(19) United States
(12) Patent Application Publication
(10) Pub. No.: US 2026/0356272 A1
(43) Pub. Date: Nov. 12, 2026

(54) AGV Lifting Mechanism and AGV with Same

(71) Applicant: Zhejiang IPLUSMOBOT Technology Co., Ltd., Hangzhou, Zhejiang (CN)

(72) Inventors: Shouxian CHEN, Hangzhou, Zhejiang (CN); Kai HUANG, Hangzhou, Zhejiang (CN); Wenhua LI, Hangzhou, Zhejiang (CN); Feng YUAN, Hangzhou, Zhejiang (CN); Lihai KONG, Hangzhou, Zhejiang (CN); Qunying CHEN, Hangzhou, Zhejiang (CN)

(21) Appl. No.: 19/515,141

(22) PCT Filed: Aug. 27, 2024
(86) PCT No.: PCT/CN2024/114912

§ 371 Date: Feb. 27, 2026

(30) Foreign Application Priority Data
Aug. 31, 2023 (CN) 202311119900.3

(51) Int. Cl. B60P 1/44

(52) U.S. Cl. CPC B60P 1/4492; B60P 1/4485

(57) ABSTRACT

The present disclosure provides an automated guided vehicle (AGV) lifting mechanism and an AGV with the same. The AGV lifting mechanism includes: a base; a bearing structure located above the base; a lifting assembly located where the lifting assembly includes a driving member, a first driven assembly, and a second driven assembly, the driving member is connected with the second driven assembly through the first driven assembly, the first driven assembly is pivotally connected with the base and the bearing structure respectively, the second driven assembly is pivotally connected with the bearing structure or the base, and the first driven assembly and the second driven assembly are driven to move by pushing and pulling the driving member; and a guide structure disposed on the base or the bearing structure and provided with a guide portion, where the guide portion cooperates with at least part of the second driven assembly.

### CROSS-REFERENCE TO RELATED APPLICATIONS

The present application is a national stage application of International Patent Application No. PCT/CN2024/114912, which is filed on Aug. 27, 2024, and claims priority to Chinese Patent Application No. 202311119900.3, filed on Aug. 31, 2023 and entitled “AGV Lifting Mechanism and AGV with Same”, the contents of which are hereby incorporated by reference in their entirety.

### TECHNICAL FIELD

The present disclosure relates to the technical field of automated guided vehicles (AGVs), and in particular to an AGV lifting mechanism and an AGV with the same.

### BACKGROUND

At present, automated guided vehicles (AGVs) are being extensively adopted and applied on a large scale, and AGV mobile machines play a crucial role in improving factory efficiency. A lifting mechanism of an AGV mobile machine is used to lift a bearing structure and a load.

In the art known to inventors, since the lifting mechanism is subjected to high levels of stress from the load and the bearing structure in a lifting process, the lifting structure is subjected to excessive stress and is prone to structural damage, which effects the overall service life of the AGV mobile machine.

To resolve the above problems, the lifting mechanism is generally made from high-strength material or constructed with a multi-linkage mechanism. However, the high-strength material increases production costs and imposes higher requirements on manufacturing precision, and the multi-linkage mechanism complicates the structure and increases the size of the lifting mechanism, and then restricts the overall size of the AGV.

### SUMMARY

A main objective of the present disclosure is to provide an automated guided vehicle (AGV) lifting mechanism and an AGV with the same, so as to solve problems of high cost and complex structure of a lifting mechanism in the art known to inventors.

In order to achieve the above objective, according to an aspect of the present disclosure, an AGV lifting mechanism is provided. The AGV lifting mechanism includes: a base; a bearing structure located above the base; a lifting assembly located between the base and the bearing structure, where the lifting assembly includes a driving member, a first driven assembly, and a second driven assembly, the driving member is connected with the second driven assembly through the first driven assembly, the first driven assembly is pivotally connected with the base and the bearing structure respectively, the second driven assembly is pivotally connected with the bearing structure or the base, and the first driven assembly and the second driven assembly are driven to move by pushing and pulling the driving member, to drive the bearing structure to lift and lower; and a guide structure disposed on the base or the bearing structure and provided with a guide portion, where the guide portion cooperates with at least part of the second driven assembly, to guide the second driven assembly.

In some embodiments, the AGV lifting mechanism further includes a limiting structure. The limiting structure includes a convex limiting portion and a concave limiting portion. One of the convex limiting portion or the concave limiting portion is disposed on the base, and the other of the convex limiting portion or the concave limiting portion is disposed on the bearing structure. The convex limiting portion extends into the concave limiting portion and is able to move in an extending direction of the concave limiting portion. The extending direction of the concave limiting portion is consistent with a lifting and lowering direction of the bearing structure.

In some embodiments, the limiting structure further includes: a first mounting portion, where the concave limiting portion is provided on the first mounting portion; and a second mounting portion, where the convex limiting portion is provided on the second mounting portion, one of the first mounting portion or the second mounting portion is disposed on the bearing structure, an other of the first mounting portion or the second mounting portion is disposed on the base, and the first mounting portion and the second mounting portion are at least partially opposite each other.

In some embodiments, the first mounting portion is disposed on the bearing structure, the second mounting portion is disposed on the base, and the first mounting portion and the second mounting portion are staggered and at least partially opposite each other. The first mounting portion is plate-shaped and includes a first plate and a second plate that are connected with each other, and the first plate is connected with the bearing structure. In a direction from the bearing structure to the base, a width of the first plate gradually decreases, a size of the second plate is constant, and a minimum width of the first plate is consistent with a width of the second plate. The second mounting portion is plate-shaped, and a width of at least part of the second mounting portion gradually increases in the direction from the bearing structure to the base.

In some embodiments, the first driven assembly includes: a first connecting rod pivotally connected with the bearing structure; a second connecting rod pivotally connected with the base; and a first connecting shaft, where the first connecting rod and the second connecting rod are rotatably fitted over the first connecting shaft, and the driving member is pivotally connected with the first connecting shaft.

In some embodiments, a length of the first connecting rod and a length of the second connecting rod are equal, the first connecting rod is disposed opposite a pivoting end of the bearing structure, and the second connecting rod is disposed opposite a pivoting end of the base, such that an angle between the first connecting rod and the first connecting shaft is the same as an angle between the second connecting rod and the first connecting shaft.

In some embodiments, the second driven assembly includes: a third connecting rod pivotally connected with the bearing structure; a fourth connecting rod, where a first end of the fourth connecting rod is rotatably fitted over the first connecting shaft; and a second connecting shaft, where the third connecting rod and a second end of the fourth connecting rod are rotatably fitted over the second connecting shaft, and at least part of the second connecting shaft cooperates with the guide portion. The third connecting rod and the first connecting rod are disposed parallel to each other, and an extending direction of the fourth connecting rod and a bearing surface of the bearing structure are disposed parallel to each other.

In some embodiments, the third connecting rod and the first connecting rod are disposed parallel to each other, such that a parallelogram structure is formed by the first connecting rod, the third connecting rod, the fourth connecting rod, and the bearing structure. The second connecting shaft and the first connecting shaft are disposed parallel to each other and located at a same height, and the second connecting shaft cooperates with the guide portion, to slide in an extending direction of the guide portion.

In some embodiments, the second driven assembly includes: a third connecting rod pivotally connected with the base; a fourth connecting rod, where a first end of the fourth connecting rod is rotatably fitted over the first connecting shaft; and a second connecting shaft, where the third connecting rod and a second end of the fourth connecting rod are rotatably fitted over the second connecting shaft, and at least part of the second connecting shaft cooperates with the guide portion. The third connecting rod and the first connecting rod are disposed parallel to each other, and an extending direction of the fourth connecting rod is disposed parallel to the base.

In some embodiments, the guide structure includes two guide portions disposed oppositely, each of the two guide portions is a concave portion, and two ends of the second connecting shaft extend into the two guide portions respectively, to slide in the extending direction of the two guide portions.

In some embodiments, the first connecting rod includes: two first rods disposed oppositely, where an end of each of the two first rods is pivotally connected with the bearing structure, and an other end of the each of the two first rods is fitted over the first connecting shaft; a second rod, where two ends of the second rod are connected with the two first rods respectively; and a third rod, where an end of the third rod is connected with the second rod, and an other end of the third rod is fitted over the first connecting shaft.

In some embodiments, the end of the each of the two first rods connected with the bearing structure is provided with a first sleeve, the first sleeve is sleeved around a first pivot shaft, to be pivotally connected with the bearing structure through the first pivot shaft, the other end of the each of the two first rods connected with the first connecting shaft is provided with a second sleeve, and the second sleeve is sleeved around the first connecting shaft.

In some embodiments, the second connecting rod includes: two fourth rods disposed oppositely, wherein an end of each of the two fourth rods is pivotally connected with the base, and an other end of the each of the two fourth rods is fitted over the first connecting shaft; a fifth rod, where two ends of the fifth rod are connected with the two fourth rods respectively; and a sixth rod, wherein an end of the sixth rod is connected with the fifth rod, and an other end of the sixth rod is fitted over the first connecting shaft.

In some embodiments, an end of the second connecting rod connected with the base is provided with a third sleeve, the third sleeve is sleeved around a second pivot shaft, to be pivotally connected with the base through the second pivot shaft, an end of the second connecting rod connected with the first connecting shaft is provided with a fourth sleeve, and the fourth sleeve is sleeved around the first connecting shaft.

In some embodiments, the third connecting rod includes two seventh rods disposed oppositely, an eighth rod, and a ninth rod, an end of each of the two seventh rods is pivotally connected with the bearing structure, an other end of the each of the two seventh rods is fitted over the second connecting shaft, two ends of the eighth rod are connected with the two seventh rods respectively, an end of the ninth rod is connected with the eighth rod, and an other end of the ninth rod is fitted over the second connecting shaft.

In some embodiments, an end of the third connecting rod connected with the bearing structure is provided with a fifth sleeve, the fifth sleeve is sleeved around a third pivot shaft, to be pivotally connected with the bearing structure through the third pivot shaft, an end of the third connecting rod connected with the second connecting shaft is provided with a sixth sleeve, and the sixth sleeve is sleeved around the second connecting shaft.

According to the other aspect of the present disclosure, an AGV is provided. The AGV includes: a chassis includes a frame assembly and an oscillating axle, where the oscillating axle is swingably disposed on the frame assembly, the oscillating axle is located on one side of the frame assembly, the frame assembly includes a front frame and a rear frame that are pivotally connected, an oscillating axis of the oscillating axle is in a traveling direction of the frame assembly; and an AGV lifting mechanism disposed on the chassis, wherein the AGV lifting mechanism includes: a base; a bearing structure located above the base; a lifting assembly located between the base and the bearing structure, where the lifting assembly includes a driving member, a first driven assembly, and a second driven assembly, the driving member is connected with the second driven assembly through the first driven assembly, the first driven assembly is pivotally connected with the base and the bearing structure respectively, the second driven assembly is pivotally connected with the bearing structure or the base, and the first driven assembly and the second driven assembly are driven to move by pushing and pulling the driving member, to drive the bearing structure to lift and lower; and a guide structure disposed on the base or the bearing structure and provided with a guide portion, where the guide portion cooperates with at least part of the second driven assembly, to guide the second driven assembly.

In some embodiments, one of the front frame and the rear frame is provided with a convex mounting portion, an other of the front frame and the rear frame is provided with a concave mounting portion, and the convex mounting portion extends into and is pivotally connected with the concave mounting portion, to connect the front frame and the rear frame.

In some embodiments, a stop structure is provided between the front frame and the rear frame. In an oscillating process of the front frame and/or the rear frame, the stop structure is used to limit and stop the front frame and/or the rear frame.

In some embodiments, the AGV further includes: a driving wheel rotatably disposed on the oscillating axle; a driven wheel rotatably disposed on the frame assembly, where the driving wheel is connected with the driven wheel, to drive the driven wheel to rotate; and a driving wheel driving device, where the driving wheel driving device is drivingly connected with the driving wheel, to drive the driving wheel to rotate, and a part of the driving wheel driving device is embedded in the oscillating axle.

By using the technical solution of the present disclosure, the AGV lifting mechanism includes: a base, a bearing structure, a lifting assembly, and a guide structure. The lifting assembly includes a driving member, a first driven assembly, and a second driven assembly. The driving member is connected with the second driven assembly through the first driven assembly. The first driven assembly is pivotally connected with the base and the bearing structure. at least part of the second driven assembly is pivotally connected with the bearing structure. The guide structure is disposed on the base and provided with a guide portion. at least part of the second driven assembly cooperates with the guide portion, such that the second driven assembly is guided through the guide portion. The first driven assembly is pivotally connected with the base and the bearing structure, a part of the second driven assembly is pivotally connected with the bearing structure, and a part of the second driven assembly cooperates with the guide portion, such that the lifting assembly has a simpler structure and is easy to process and achieve. In this way, when a load placed on the bearing structure needs to be lifted, the driving member is pushed or pulled to drive the first driven assembly to move. The first driven assembly synchronously drives the second driven assembly to move, such that the bearing structure and the load are synchronously driven to lift through the first driven assembly and the second driven assembly.

Compared with a lifting mechanism in the art known to inventors, the lifting assembly in the present disclosure has a simpler structure and is easy to process and achieve, such that processing cost and disassembly difficulty of the lifting assembly are further reduced. The problems of high cost and complex structure of the lifting mechanism in the art known to inventors is solved. Meanwhile, in a process that the lifting assembly drives the bearing structure and the load to lift, the guide structure guides the lifting and lowering direction of the second driven assembly, such that lifting stability of the bearing structure is further improved. At present, the AGV is required to be small in size, low in manufacturing cost and large in load, and the structure adopted in the present disclosure can effectively reduce a size of the whole machine and facilitate a layout of the whole vehicle. Synchronous lifting is performed in a connecting rod and slide groove combination mode. When the lifting structure of the whole vehicle is influenced by an external torsional force, internal stress can be released through a gap of slide grooves, such that machining precision requirements of the whole vehicle on related parts are reduced, and the cost is reduced.

### BRIEF DESCRIPTION OF THE DRAWINGS

The accompanying drawings of the specification forming a part of the disclosure serve to provide a further understanding of the disclosure, and the illustrative examples of the disclosure and the description of the illustrative examples serve to explain the disclosure and are not to be construed as unduly limiting the disclosure. In the drawings:

FIG. 1 is a front view of embodiment 1 of an AGV lifting mechanism according to the present disclosure;

FIG. 2 is a schematic diagram of a three-dimensional structure of the AGV lifting mechanism in FIG. 1;

FIG. 3 is a schematic diagram of the three-dimensional structure of the AGV lifting mechanism in FIG. 2 from another angle;

FIG. 4 is a schematic cooperation diagram of a limiting structure of the AGV lifting mechanism in FIG. 1;

FIG. 5 is a schematic diagram of a three-dimensional structure after assembly of a chassis of an embodiment of an AGV and an AGV lifting mechanism according to the present disclosure;

FIG. 6 is a schematic diagram of a three-dimensional structure of the chassis of the AGV in FIG. 5;

FIG. 7 is a schematic diagram of the three-dimensional structure of the chassis in FIG. 5 from another angle;

FIG. 8 is a partially enlarged schematic view of the chassis in FIG. 5;

FIG. 9 is a schematic diagram of a three-dimensional structure after assembly of an oscillating axle, a driving wheel and a driving wheel driving device of the AGV in FIG. 5;

FIG. 10 is a schematic diagram of a three-dimensional structure of the oscillating axle assembled with the driving wheel driving device in FIG. 9; and

FIG. 11 is a front view of embodiment 2 of an AGV lifting mechanism according to the present disclosure.

The drawings include the following reference numerals:
10. base;
20. bearing structure;
30. lifting assembly; 31. driving member; 32. first driven assembly; 321. first connecting rod; 3211. first rod; 3212. second rod; 3213. third rod; 322. second connecting rod; 3221. fourth rod; 3222. fifth rod; 3223. sixth rod; 323. first connecting shaft; 33. second driven assembly; 331. third connecting rod; 3311. seventh rod; 3312. eighth rod; 3313. ninth rod; 332. fourth connecting rod; 333. second connecting shaft;
40. guide structure; 41. guide portion;
50. limiting structure; 51. convex limiting portion; 52. concave limiting portion; 53. first mounting portion; 54. second mounting portion;
60. chassis; 61. front frame; 62. rear frame; 63. oscillating axle; 64. convex mounting portion; 65. concave mounting portion; 67. rotating shaft;
71. driving wheel; 72. driven wheel; 73. driving wheel driving device; and
80. AGV lifting mechanism.

### DETAILED DESCRIPTION OF THE EMBODIMENTS

It should be noted that the examples in the disclosure and features in the examples can be combined without conflicts. The disclosure will be described below with reference to the drawings and in combination with the examples in detail.

It should be noted that unless otherwise defined, all technical and scientific terms used in the disclosure have the same meanings usually understood by the general technical personnel in the technical field of the disclosure.

In the present disclosure, directional terms such as “upper” and “lower” are used generally with respect to directions shown in the drawings, or with respect to vertical, perpendicular, or gravitational directions, without being described to the contrary. Similarly, for ease of understanding and description, “left” and “right” are generally directed to left and right as shown in the accompanying drawings; and “inner” and “outer” refer to inner and outer relative to contours of the components, but the above directional terms are not intended to limit the present disclosure.

In order to solve problems of high cost and complex structure of a lifting mechanism in the art known to inventors, the present disclosure provides an automated guided vehicle (AGV) lifting mechanism and an AGV with the same.

### Example 1

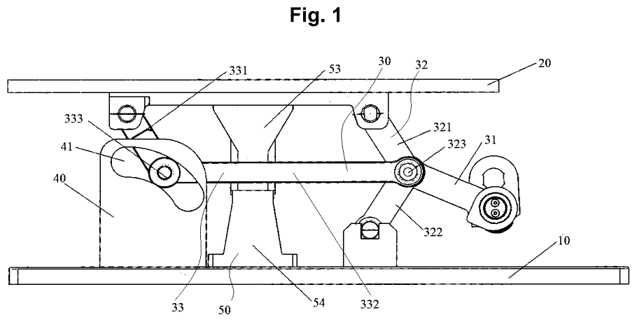

As shown in FIG. 1 to FIG. 3, the AGV lifting mechanism includes a base 10, a bearing structure 20, a lifting assembly 30, and a guide structure 40. The bearing structure 20 is located above the base 10. The lifting assembly 30 is located between the base 10 and the bearing structure 20. The lifting assembly 30 includes a driving member 31, a first driven assembly 32, and a second driven assembly 33. The driving member 31 is connected with the second driven assembly 33 through the first driven assembly 32. The first driven assembly 32 is pivotally connected with the base 10 and the bearing structure 20 respectively. The second driven assembly 33 is pivotally connected with the bearing structure 20. The first driven assembly 32 and the second driven assembly 33 are driven to move by pushing and pulling the driving member 31, to drive the bearing structure 20 to lift and lower. The guide structure 40 is disposed on the base 10 and provided with a guide portion 41. The guide portion 41 cooperates with at least part of the second driven assembly 33, to guide the second driven assembly 33.

By using the technical solution of the example, the first driven assembly 32 is pivotally connected with the base 10 and the bearing structure 20. A part of the second driven assembly 33 is pivotally connected with the bearing structure 20, and a part of the second driven assembly cooperates with the guide portion 41, such that the lifting assembly 30 has a simpler structure and is easy to process and achieve. When a load placed on the bearing structure 20 needs to be lifted, the driving member 31 is pushed or pulled to drive the first driven assembly 32 to move. The first driven assembly 32 synchronously drives the second driven assembly 33 to move, such that the bearing structure 20 and the load are synchronously driven to lift and lower through the first driven assembly 32 and the second driven assembly 33.

Compared with a lifting mechanism in the art known to inventors, the lifting assembly 30 in the example has a simpler structure and is easy to process and achieve, such that processing cost and disassembly difficulty of the lifting assembly 30 are further reduced. The problems of high cost and complex structure of the lifting mechanism in the art known to inventors is solved. Meanwhile, in a process that the lifting assembly 30 drives the bearing structure 20 and the load to lift and lower, the guide structure 40 guides the lifting and lowering direction of the second driven assembly 33, such that lifting stability of the bearing structure 20 is further improved. At present, the AGV is required to be small in size, low in manufacturing cost and large in load, and the structure adopted in the present disclosure can effectively reduce a size of the whole machine and facilitate a layout of the whole vehicle. Synchronous lifting is performed in a connecting rod and slide groove combination mode. When the lifting structure of the whole vehicle is influenced by an external torsional force, internal stress can be released through a gap of slide grooves, such that machining precision requirements of the whole vehicle on related parts are reduced, and the cost is reduced.

In the example, an existing complex connecting rod lifting mechanism is simplified. A stress issue of the lifting assembly is solved under conditions of a simple and compact structure and low material requirements.

Specifically, when the driving member 31 is pulled, the first driven assembly 32 and the second driven assembly 33 drive the bearing structure 20 and the load to descend synchronously. When the driving member 31 is pushed, the first driven assembly 32 and the second driven assembly 33 drive the bearing structure 20 and the load to ascend synchronously.

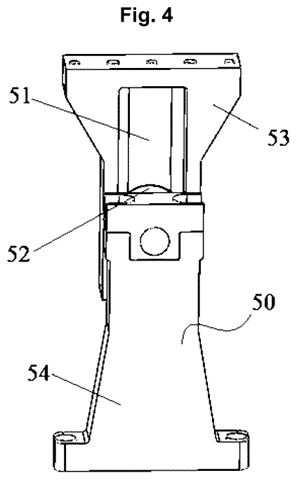

As shown in FIG. 1, FIG. 3, and FIG. 4, the AGV lifting mechanism further includes a limiting structure 50. The limiting structure 50 includes a convex limiting portion 51 and a concave limiting portion 52. One of the convex limiting portion 51 or the concave limiting portion 52 is disposed on the base 10, and the other of the convex limiting portion 51 or the concave limiting portion 52 is disposed on the bearing structure 20. The convex limiting portion 51 extends into the concave limiting portion 52 and is able to move in an extending direction of the concave limiting portion 52. The extending direction of the concave limiting portion 52 is consistent with a lifting and lowering direction of the bearing structure 20. In this way, when the lifting assembly 30 drives the bearing structure 20 and the load to move lift, the limiting structure 50 is used to guide and limit a movement direction of the bearing structure 20, to guarantee that the bearing structure 20 always lifts in a height direction. Thus the lifting stability and reliability of the lifting assembly 30 are improved. Moreover, the above disposition makes disposition positions of the convex limiting portion 51 and the concave limiting portion 52 more flexible, to satisfy different use requirements and working conditions. Processing flexibility of workers is also improved.

In the example, the convex limiting portion 51 is disposed on the base 10, and the concave limiting portion 52 is disposed on the bearing structure 20. The convex limiting portion 51 extends into the concave limiting portion 52 and is able to move in an extending direction of the concave limiting portion 52.

In some embodiments, one limiting structure 50 is provided; or a plurality of limiting structures 50 are provided, and the plurality of limiting structures 50 are spaced in a length direction and/or width direction of the bearing structure 20.

As shown in FIG. 3 and FIG. 4, the limiting structure 50 further includes a first mounting portion 53 and a second mounting portion 54. The concave limiting portion 52 is provided on the first mounting portion 53. The convex limiting portion 51 is provided on the second mounting portion 54. One of the first mounting portion 53 or the second mounting portion 54 is disposed on the bearing structure 20. An other of the first mounting portion 53 or the second mounting portion 54 is disposed on the base 10. The first mounting portion 53 and the second mounting portion 54 are at least partially opposite each other. In this way, through the above disposition, the limiting structure 50 has a simpler structure and is easy to process and achieve. Processing cost and difficulty of the limiting structure 50 are reduced.

Specifically, the first mounting portion 53 is disposed on the bearing structure 20. The second mounting portion 54 is disposed on the base 10. The first mounting portion and the second mounting portion are staggered and at least partially opposite each other, to guarantee that they can cooperate with each other.

In the example, the first mounting portion 53 is plate-shaped and includes a first plate and a second plate that are connected with each other. The first plate is connected with the bearing structure 20. In a direction from the bearing structure 20 to the base 10, a width of the first plate gradually decreases, a size of the second plate is constant, and a minimum width of the first plate is consistent with a width of the second plate. Thus structural strength of the first mounting portion 53 is increased.

In the example, the second mounting portion 54 is plate-shaped, and a width of at least part of the second mounting portion 54 gradually increases in the direction from the bearing structure 20 to the base 10. Thus structural strength of the second mounting portion 54 is increased.

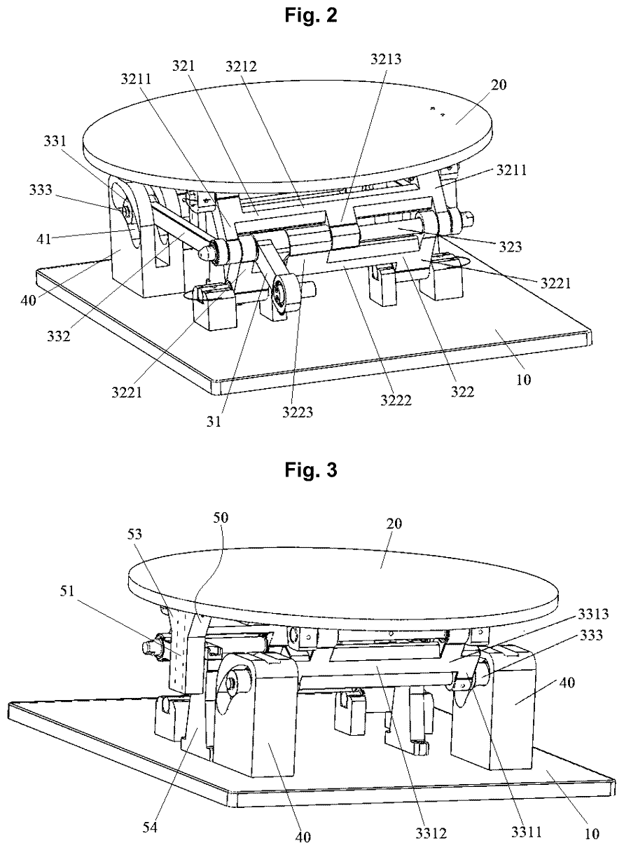

As shown in FIG. 1 and FIG. 2, the first driven assembly 32 includes a first connecting rod 321, a second connecting rod 322, and a first connecting shaft 323. The first connecting rod 321 is pivotally connected with the bearing structure 20. The second connecting rod 322 is pivotally connected with the base 10. The first connecting rod 321 and the second connecting rod 322 are rotatably fitted over the first connecting shaft 323. The driving member 31 is pivotally connected with the first connecting shaft 323. In this way, through the above disposition, the first driven assembly 32 has a simpler structure and is easy to process and achieve. Processing cost and difficulty of the first driven assembly 32 are reduced. Moreover, the above disposition guarantees that the first driven assembly 32 can drive the bearing structure 20 to lift and lower, thereby improving movement reliability of the first driven assembly 32.

Specifically, a length of the first connecting rod 321 and a length of the second connecting rod 322 are equal. The first connecting rod 321 is disposed opposite a pivoting end of the bearing structure 20, and the second connecting rod 322 is disposed opposite a pivoting end of the base 10, such that the first connecting rod and the second connecting rod form the same angles with the first connecting shaft 323.

As shown in FIG. 1 and FIG. 2, the second driven assembly 33 includes a third connecting rod 331, a fourth connecting rod 332, and a second connecting shaft 333. The third connecting rod 331 is pivotally connected with the bearing structure 20. A first end of the fourth connecting rod 332 is rotatably fitted over the first connecting shaft 323. The third connecting rod 331 and a second end of the fourth connecting rod 332 are rotatably fitted over the second connecting shaft 333. at least part of the second connecting shaft 333 cooperates with the guide portion 41. The third connecting rod 331 and the first connecting rod 321 are disposed parallel to each other. An extending direction of the fourth connecting rod 332 and a bearing surface of the bearing structure 20 are disposed parallel to each other. In this way, through the above disposition, the second driven assembly 33 has a simpler structure and is easy to process and achieve. Processing cost and difficulty of the second driven assembly 33 are reduced. Moreover, the above disposition guarantees that the second driven assembly 33 can drive the bearing structure 20 to lift and lower, thereby improving movement reliability of the second driven assembly 33.

Specifically, the third connecting rod 331 and the first connecting rod 321 are disposed parallel to each other, such that a parallelogram structure is formed by the first connecting rod 321, the third connecting rod 331, the fourth connecting rod 332, and the bearing structure 20. Thus the lifting stability of the lifting assembly 30 is improved. The second connecting shaft 333 and the first connecting shaft 323 are disposed parallel to each other and located at a same height. The second connecting shaft 333 cooperates with the guide portion 41, to slide in an extending direction of the guide portion 41.

As shown in FIG. 1 to FIG. 3, the guide structure 40 includes two guide portions 41 disposed oppositely. Each of the two guide portions 41 is a concave portion. Two ends of the second connecting shaft 333 extend into the two guide portions 41 respectively, to slide in the extending direction of the two guide portions 41. The concave portion is arc-shaped, and a center of a circle is located below the concave portion. In this way, through the above disposition, a contact area between the guide portion 41 and the second connecting shaft 333 is increased, and guide reliability and stability of the guide portion 41 to the second connecting shaft 333 are further improved.

Specifically, the guide structure 40 includes two guide plates that are opposite each other. The fourth connecting rod 332 is located between the two guide plates. Each guide plate has a guide portion 41. Thus connection stability between the guide structure 40 and the second driven assembly 33 is improved.

In the example, each concave portion is a kidney-shaped hole.

In some embodiments, the convex limiting portion 51 is a bearing or a wheel. In this way, through the above disposition, on one hand, structure selection of the convex limiting portion 51 is more flexible to satisfy different use requirements and working conditions, and the processing flexibility of workers is also improved. On the other hand, a friction force between the convex limiting portion 51 and the concave limiting portion 52 is a rolling friction force, which reduces structural wear of the first mounting portion 53 and the second mounting portion 54, and prolongs service life of the limiting structure 50.

In the example, the convex limiting portion 51 is a bearing.

As shown in FIG. 2, the first connecting rod 321 includes two first rods 3211 disposed oppositely, a second rod 3212, and a third rod 3213. An end of each of the two first rods 3211 is pivotally connected with the bearing structure 20, and an other end of the each of the two first rods 3211 is fitted over the first connecting shaft 323. Two ends of the second rod 3212 are connected with the two first rods 3211 respectively. An end of the third rod 3213 is connected with the second rod 3212, and an other end of the third rod 3213 is fitted over the first connecting shaft 323. And/or, the second connecting rod 322 includes two fourth rods 3221 disposed oppositely, a fifth rod 3222, and a sixth rod 3223. One end of each of the fourth rods 3221 is pivotally connected with the base 10, and the other end is fitted over the first connecting shaft 323. Two ends of the fifth rod 3222 are connected with the two fourth rods 3221 respectively. One end of the sixth rod 3223 is connected with the fifth rod 3222, and the other end of the sixth rod 3223 is fitted over the first connecting shaft 323. In this way, through the above disposition, the first connecting rod 321 and/or the second connecting rod 322 have/has a simpler structure and are/is easy to process and achieve. Processing cost and difficulty of the first connecting rod 321 and/or the second connecting rod 322 are reduced.

In the example, the first connecting rod 321 includes two first rods 3211 disposed oppositely, a second rod 3212, and a third rod 3213. The end of each of the first rods 3211 is pivotally connected with the bearing structure 20, and the other end of the each of the two first rods 3211 is fitted over the first connecting shaft 323. Two ends of the second rod 3212 are connected with the two first rods 3211 respectively. The end of the third rod 3213 is connected with the second rod 3212, and the other end of the third rod 3213 is fitted over the first connecting shaft 323. In this way, through the above disposition, the first connecting rod 321 has an H-shaped structure, which improves connection stability of the first connecting rod 321 and the bearing structure 20 to the first connecting shaft 323, disperses stress of the first connecting shaft 323, reduces material requirements of the first connecting shaft 323, and avoids the first connecting rod 321 from falling off and influencing lifting reliability of the lifting assembly 30. Moreover, the third rod 3213 plays a reinforcing role.

Specifically, the end of the each of the two first rods 3211 connected with the bearing structure 20 is provided with a first sleeve. The first sleeve is sleeved around a first pivot shaft, to be pivotally connected with the bearing structure 20 through the first pivot shaft. The other of the each of the two first rods 3211 connected with the first connecting shaft 323 is provided with a second sleeve. The second sleeve is sleeved around the first connecting shaft 323.

In the example, the second connecting rod 322 includes two fourth rods 3221 disposed oppositely, a fifth rod 3222, and a sixth rod 3223. An end of each of the two fourth rods 3221 is pivotally connected with the base 10, and an other end of the each of the two fourth rods 3221 is fitted over the first connecting shaft 323. Two ends of the fifth rod 3222 are connected with the two fourth rods 3221 respectively. An end of the sixth rod 3223 is connected with the fifth rod 3222, and an other end of the sixth rod 3223 is fitted over the first connecting shaft 323. In this way, through the above disposition, the second connecting rod 322 has an H-shaped structure, which improves connection stability of the second connecting rod 322 and the base 10 to the first connecting shaft 323, disperses stress of the first connecting shaft 323, reduces material requirements of the first connecting shaft 323, and avoids the second connecting rod 322 from falling off and influencing lifting reliability of the lifting assembly 30. Moreover, the sixth rod 3223 plays a reinforcing role.

Specifically, an end of the second connecting rod 322 connected with the base 10 is provided with a third sleeve. The third sleeve is sleeved around a second pivot shaft, to be pivotally connected with the base 10 through the second pivot shaft. An end of the second connecting rod 322 connected with the first connecting shaft 323 is provided with a fourth sleeve. The fourth sleeve is sleeved around the first connecting shaft 323.

In the example, the third connecting rod 331 includes two seventh rods 3311 disposed oppositely, an eighth rod 3312, and a ninth rod 3313. An end of each of the two seventh rods 3311 is pivotally connected with the bearing structure 20, and an other end the each of the two seventh rods 3311 is fitted over the second connecting shaft 333. Two ends of the eighth rod 3312 are connected with the two seventh rods 3311 respectively. An end of the ninth rod 3313 is connected with the eighth rod 3312, and an other end of the ninth rod 3313 is fitted over the second connecting shaft 333. In this way, through the above disposition, the third connecting rod 331 has an H-shaped structure, which improves connection stability of the third connecting rod 331 and the bearing structure 20 to the second connecting shaft 333, disperses stress of the second connecting shaft 333, reduces material requirements of the second connecting shaft 333, and avoids the third connecting rod 331 from falling off and influencing lifting reliability of the lifting assembly 30. Moreover, the ninth rod 3313 plays a reinforcing role.

Specifically, an end of the third connecting rod 331 connected with the bearing structure 20 is provided with a fifth sleeve. The fifth sleeve is sleeved around a third pivot shaft, to be pivotally connected with the bearing structure 20 through the third pivot shaft. An end of the third connecting rod 331 connected with the second connecting shaft 333 is provided with a sixth sleeve. The sixth sleeve is sleeved around the second connecting shaft 333.

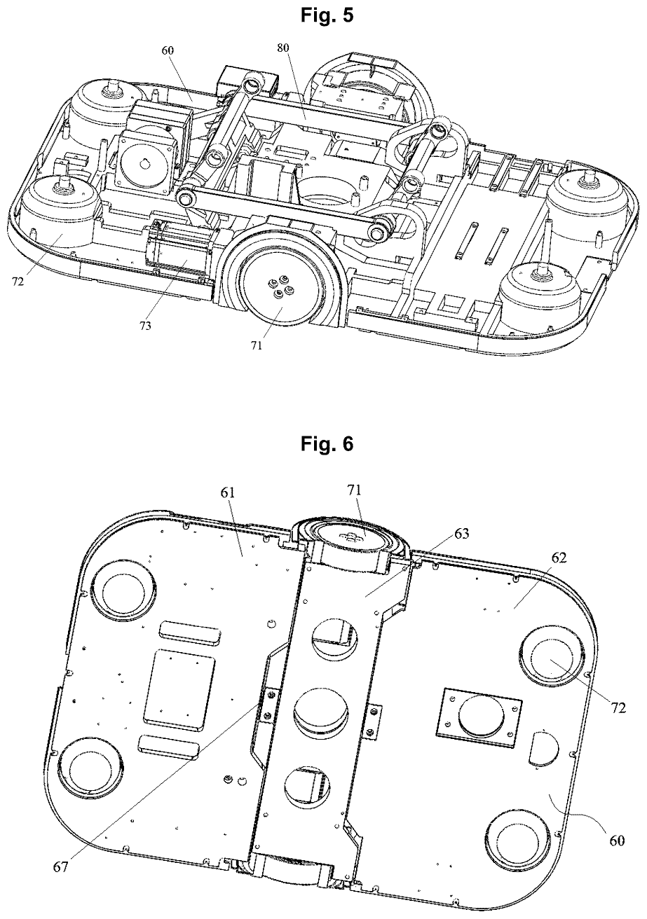

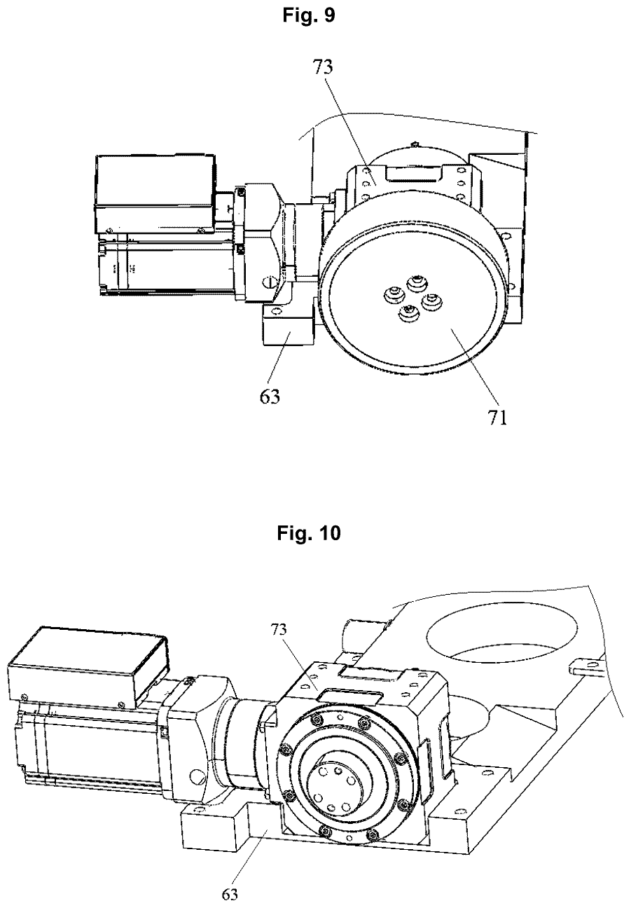

As shown in FIG. 5 to FIG. 10, the present disclosure further provides an AGV. The AGV includes a chassis 60 and an AGV lifting mechanism 80. The chassis 60 includes a frame assembly and an oscillating axle 63. The oscillating axle 63 is swingably disposed on the frame assembly. The oscillating axle 63 is located on one side of the frame assembly. The frame assembly includes a front frame 61 and a rear frame 62 that are pivotally connected. An oscillating axis of the oscillating axle 63 is in a traveling direction of the frame assembly. The AGV lifting mechanism 80 is disposed on the chassis 60. The AGV lifting mechanism 80 is the above AGV lifting mechanism.

Specifically, the chassis 60 is disposed in three sections, that is, includes the front frame 61, the rear frame 62, and the oscillating axle 63. Through the above disposition, the chassis 60 can oscillate in a left-right direction and a front-rear direction to adapt to bumpy road conditions.

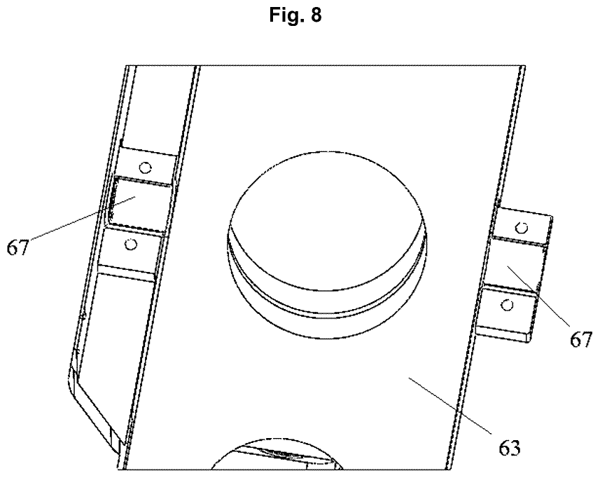

As shown in FIG. 8, the chassis 60 further includes a rotating shaft 67. The oscillating axle 63 is fitted over the rotating shaft 67 and can rotate relative to the rotating shaft 67.

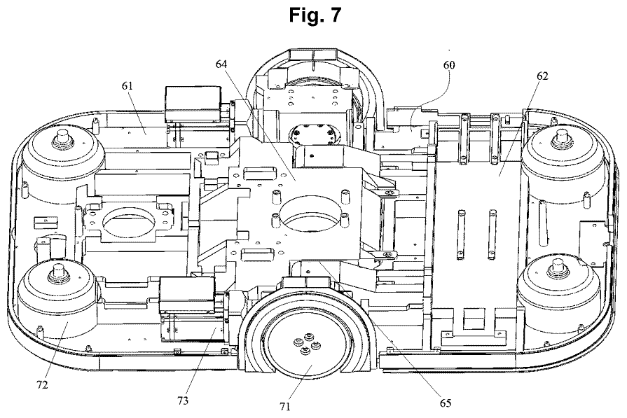

As shown in FIG. 7, one of the front frame 61 and the rear frame 62 is provided with a convex mounting portion 64. An other of the front frame 61 and the rear frame 62 is provided with a concave mounting portion 65. The convex mounting portion 64 extends into and is pivotally connected with the concave mounting portion 65, to connect the front frame 61 and the rear frame 62. In this way, a contact area between the front frame 61 and the rear frame 62 is increased, such that connection stability between the front frame and the rear frame is improved, and structural stability of the chassis 60 is prevented from being influenced by separation of the front frame and the rear frame.

Specifically, the front frame 61 is provided with the convex mounting portion 64. The rear frame 62 is provided with the concave mounting portion 65.

As shown in FIG. 7, a stop structure is provided between the front frame 61 and the rear frame 62. In an oscillating process of the front frame 61 and/or the rear frame 62, the stop structure is used to limit and stop the front frame 61 and/or the rear frame 62. In this way, when the chassis 60 oscillates in the front-rear direction, the stop structure is used to limit and stop the front frame 61 and/or the rear frame 62, to prevent the chassis 60 from excessively oscillating and influencing structural stability of other parts mounted on the chassis.

In some embodiments, one stop structure is provided; or a plurality of stop structures are provided, and the plurality of stop structures are perpendicular to the traveling direction of the frame assembly.

In the example, two stop structures are provided, thereby reducing processing cost of the stop structures.

As shown in FIG. 7 to FIG. 10, the AGV further includes a driving wheel 71, a driven wheel 72, and a driving wheel driving device 73. The driving wheel 71 is rotatably disposed on the oscillating axle 63. The driven wheel 72 is rotatably disposed on the frame assembly. The driving wheel 71 is connected with the driven wheel 72, to drive the driven wheel 72 to rotate. The driving wheel driving device 73 is drivingly connected with the driving wheel 71, to drive the driving wheel 71 to rotate. A part of the driving wheel driving device 73 is embedded in the oscillating axle 63. The other part of the driving wheel driving device 73 is erected on the front frame 61 or the rear frame 62.

Specifically, the oscillating axle 63 is provided with a concave accommodation portion. A part of the driving wheel driving device 73 is embedded in the concave accommodation portion.

### Example 2

A difference between the AGV lifting mechanisms of Example 2 and Example 1 lies in that a connection mode of the second driven assembly 33 is different.

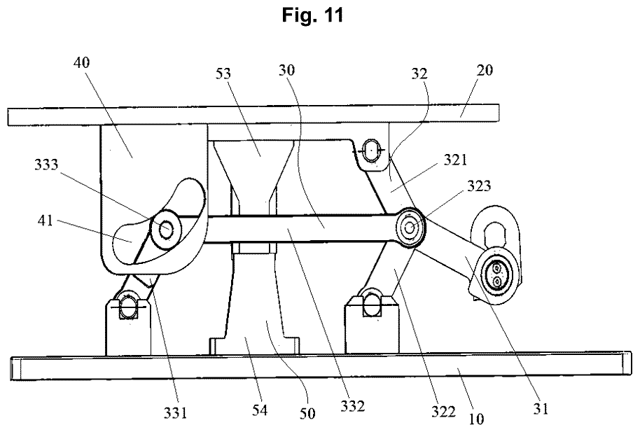

As shown in FIG. 11, the second driven assembly 33 is pivotally connected with the base 10, and the guide structure 40 is disposed on the bearing structure 20. The second driven assembly 33 includes a third connecting rod 331, a fourth connecting rod 332, and a second connecting shaft 333. The third connecting rod 331 is pivotally connected with the base 10. A first end of the fourth connecting rod 332 is rotatably fitted over the first connecting shaft 323. The third connecting rod 331 and a second end of the fourth connecting rod 332 are rotatably fitted over the second connecting shaft 333. at least part of the second connecting shaft 333 cooperates with the guide portion 41. The third connecting rod 331 and the first connecting rod 321 are disposed parallel to each other. An extending direction of the fourth connecting rod 332 is disposed parallel to the base 10.

It can be seen from the above description that the examples of the present disclosure implement the technical effects as follows:

The AGV lifting mechanism includes: a base, a bearing structure, a lifting assembly, and a guide structure. The lifting assembly includes a driving member, a first driven assembly, and a second driven assembly. The driving member is connected with the second driven assembly through the first driven assembly. The first driven assembly is pivotally connected with the base and the bearing structure. at least part of the second driven assembly is pivotally connected with the bearing structure. The guide structure is disposed on the base and provided with a guide portion. at least part of the second driven assembly cooperates with the guide portion, such that the second driven assembly is guided through the guide portion. The first driven assembly is pivotally connected with the base and the bearing structure, a part of the second driven assembly is pivotally connected with the bearing structure, and a part of the second driven assembly cooperates with the guide portion, such that the lifting assembly has a simpler structure and is easy to process and achieve. In this way, when a load placed on the bearing structure needs to be lifted, the driving member is pushed or pulled to drive the first driven assembly to move. The first driven assembly synchronously drives the second driven assembly to move, such that the bearing structure and the load are synchronously driven to lift and lower through the first driven assembly and the second driven assembly.

Compared with a lifting mechanism in the art known to inventors, the lifting assembly in the present disclosure has a simpler structure and is easy to process and achieve, such that processing cost and disassembly difficulty of the lifting assembly are further reduced. The problems of high cost and complex structure of the lifting mechanism in the art known to inventors is solved. Meanwhile, in a process that the lifting assembly drives the bearing structure and the load to lift and lower, the guide structure guides the lifting and lowering direction of the second driven assembly, such that lifting stability of the bearing structure is further improved. At present, the AGV is required to be small in size, low in manufacturing cost and large in load, and the structure adopted in the present disclosure can effectively reduce a size of the whole machine and facilitate a layout of the whole vehicle. Synchronous lifting is performed in a connecting rod and slide groove combination mode. When the lifting structure of the whole vehicle is influenced by an external torsional force, internal stress can be released through a gap of slide grooves, such that machining precision requirements of the whole vehicle on related parts are reduced, and the cost is reduced.

Apparently, the examples described are merely some examples rather than all examples of the present disclosure. Based on the examples of the present disclosure, all other examples derived by those of ordinary skill in the art without creative efforts should fall within the scope of protection of the present disclosure.

It should be noted that the terms used herein are for the purpose of describing detailed embodiments merely and are not intended to limit the illustrative embodiments in accordance with the present disclosure. As used herein, the singular is intended to include the plural unless the context clearly dictates. Furthermore, it is to be understood that the terms “include” and/or “comprise” used in this specification specify the presence of features, steps, works, devices, components, and/or their combinations.

It should be noted that the terms “first”, “second” and so forth in the specification and claims of the present disclosure and in the above-mentioned drawings are used to distinguish between similar objects and not necessarily to describe a particular order or sequential order. It should be understood that the data used in this way can be interchanged where appropriate, such that the examples of the present disclosure described herein can be implemented in other sequences than those illustrated or described herein.

What are described above are merely preferred examples of the present disclosure, and are not intended to limit the present disclosure. Those skilled in the art can make various changes and variations to the present disclosure. Any modifications, equivalent replacements, improvements, etc. made within the spirit and principles of the disclosure should fall within the scope of protection of the disclosure.

1. An automated guided vehicle (AGV) lifting mechanism, comprising:
a base;
a bearing structure located above the base;
a lifting assembly located between the base and the bearing structure, wherein the lifting assembly comprises a driving member, a first driven assembly, and a second driven assembly, the driving member is connected with the second driven assembly through the first driven assembly, the first driven assembly is pivotally connected with the base and the bearing structure respectively, the second driven assembly is pivotally connected with the bearing structure or the base, and the first driven assembly and the second driven assembly are driven to move by pushing and pulling the driving member, to drive the bearing structure to lift and lower; and
a guide structure disposed on the base or the bearing structure and provided with a guide portion, wherein the guide portion cooperates with at least part of the second driven assembly, to guide the second driven assembly.

2. The AGV lifting mechanism as claimed in claim 1, further comprising:
a limiting structure comprising a convex limiting portion and a concave limiting portion, wherein one of the convex limiting portion and the concave limiting portion is disposed on the base, an other of the convex limiting portion and the concave limiting portion is disposed on the bearing structure, the convex limiting portion extends into the concave limiting portion and is able to move in an extending direction of the concave limiting portion, and the extending direction of the concave limiting portion is consistent with a lifting and lowering direction of the bearing structure.

3. The AGV lifting mechanism as claimed in claim 2, wherein the limiting structure further comprises:
a first mounting portion, wherein the concave limiting portion is provided on the first mounting portion; and
a second mounting portion, wherein the convex limiting portion is provided on the second mounting portion;
one of the first mounting portion and the second mounting portion is disposed on the bearing structure, an other of the first mounting portion and the second mounting portion is disposed on the base, and the first mounting portion and the second mounting portion are at least partially opposite each other.

4. The AGV lifting mechanism as claimed in claim 3, wherein
the first mounting portion is disposed on the bearing structure , the second mounting portion is disposed on the base, and the first mounting portion and the second mounting portion are staggered and at least partially opposite each other;
the first mounting portion is plate-shaped and comprises a first plate and a second plate that are connected with each other, and the first plate is connected with the bearing structure; in a direction from the bearing structure to the base, a width of the first plate gradually decreases, a size of the second plate is constant, and a minimum width of the first plate is consistent with a width of the second plate; and
the second mounting portion is plate-shaped, and a width of at least part of the second mounting portion gradually increases in the direction from the bearing structure to the base.

5. The AGV lifting mechanism as claimed in claim 1, wherein the first driven assembly comprises:
a first connecting rod pivotally connected with the bearing structure;
a second connecting rod pivotally connected with the base; and
a first connecting shaft, wherein the first connecting rod and the second connecting rod are rotatably fitted over the first connecting shaft, and the driving member is pivotally connected with the first connecting shaft.

6. The AGV lifting mechanism as claimed in claim 5, wherein a length of the first connecting rod and a length of the second connecting rod are equal, the first connecting rod is disposed opposite a pivoting end of the bearing structure, and the second connecting rod is disposed opposite a pivoting end of the base, such that an angle between the first connecting rod and the first connecting shaft is the same as an angle between the second connecting rod and the first connecting shaft.

7. The AGV lifting mechanism as claimed in claim 5, wherein the second driven assembly comprises:
a third connecting rod pivotally connected with the bearing structure;
a fourth connecting rod, wherein a first end of the fourth connecting rod is rotatably fitted over the first connecting shaft; and
a second connecting shaft, wherein the third connecting rod and a second end of the fourth connecting rod are rotatably fitted over the second connecting shaft, and at least part of the second connecting shaft cooperates with the guide portion; and
the third connecting rod and the first connecting rod are disposed parallel to each other, and an extending direction of the fourth connecting rod and a bearing surface of the bearing structure are disposed parallel to each other.

8. The AGV lifting mechanism as claimed in claim 7, wherein
the third connecting rod and the first connecting rod are disposed parallel to each other, such that a parallelogram structure is formed by the first connecting rod, the third connecting rod, the fourth connecting rod, and the bearing structure; and
the second connecting shaft and the first connecting shaft are disposed parallel to each other and located at a same height, and the second connecting shaft cooperates with the guide portion, to slide in an extending direction of the guide portion.

9. The AGV lifting mechanism as claimed in claim 5, wherein the second driven assembly comprises:
a third connecting rod pivotally connected with the base;
a fourth connecting rod, wherein a first end of the fourth connecting rod is rotatably fitted over the first connecting shaft; and
a second connecting shaft wherein the third connecting rod and a second end of the fourth connecting rod are rotatably fitted over the second connecting shaft, and at least part of the second connecting shaft cooperates with the guide portion; and
the third connecting rod and the first connecting rod are disposed parallel to each other, and an extending direction of the fourth connecting rod is disposed parallel to the base.

10. The AGV lifting mechanism as claimed in claim 8, wherein the guide structure comprises two guide portions disposed oppositely, each of the two guide portions is a concave portion, and two ends of the second connecting shaft extend into the two guide portions respectively, to slide in the extending direction of the two guide portions.

11. The AGV lifting mechanism as claimed in claim 5, wherein
the first connecting rod comprises:
two first rods disposed oppositely, wherein an end of each of the two first rods is pivotally connected with the bearing structure [[(20)]], and an other end of the each of the two first rods is fitted over the first connecting shaft;
a second rod, wherein two ends of the second rod are connected with the two first rods respectively; and
a third rod wherein an end of the third rod is connected with the second rod, and an other end of the third rod is fitted over the first connecting shaft.

12. The AGV lifting mechanism as claimed in claim 11, wherein the end of the each of the two first rods connected with the bearing structure is provided with a first sleeve, the first sleeve is sleeved around a first pivot shaft, to be pivotally connected with the bearing structure through the first pivot shaft, the other end of the each of the two first rods connected with the first connecting shaft is provided with a second sleeve, and the second sleeve is sleeved around the first connecting shaft.

13. The AGV lifting mechanism as claimed in claim 5, wherein
the second connecting rod comprises:
two fourth rods disposed oppositely, wherein an end of each of the two fourth rods is pivotally connected with the base, and an other end of the each of the two fourth rods is fitted over the first connecting shaft;
a fifth rod, wherein two ends of the fifth rod are connected with the two fourth rods respectively; and
a sixth rod, wherein an end of the sixth rod is connected with the fifth rod, and an other end of the sixth rod is fitted over the first connecting shaft.

14. The AGV lifting mechanism as claimed in claim 13, wherein an end of the second connecting rod connected with the base is provided with a third sleeve, the third sleeve is sleeved around a second pivot shaft, to be pivotally connected with the base through the second pivot shaft, an end of the second connecting rod connected with the first connecting shaft is provided with a fourth sleeve, and the fourth sleeve is sleeved around the first connecting shaft.

15. The AGV lifting mechanism as claimed in claim 7, wherein the third connecting rod comprises two seventh rods disposed oppositely, an eighth rod, and a ninth rod, an end of each of the two seventh rods is pivotally connected with the bearing structure, an other end of the each of the two seventh rods is fitted over the second connecting shaft, two ends of the eighth rod are connected with the two seventh rods respectively, an end of the ninth rod is connected with the eighth rod, and an other end of the ninth rod is fitted over the second connecting shaft.

16. The AGV lifting mechanism as claimed in claim 15, wherein an end of the third connecting rod connected with the bearing structure is provided with a fifth sleeve, the fifth sleeve is sleeved around a third pivot shaft, to be pivotally connected with the bearing structure through the third pivot shaft, an end of the third connecting rod connected with the second connecting shaft is provided with a sixth sleeve, and the sixth sleeve is sleeved around the second connecting shaft.

17. An AGV, comprising:
a chassis comprising a frame assembly and an oscillating axle, wherein the oscillating axle is swingably disposed on the frame assembly, the oscillating axle is located on a side of the frame assembly, the frame assembly comprises a front frame and a rear frame that are pivotally connected, an oscillating axis of the oscillating axle is in a traveling direction of the frame assembly; and
an AGV lifting mechanism disposed on the chassis, wherein
the AGV lifting mechanism comprises:
a base;
a bearing structure located above the base;
a lifting assembly located between the base and the bearing structure, wherein the lifting assembly comprises a driving member, a first driven assembly, and a second driven assembly, the driving member is connected with the second driven assembly through the first driven assembly, the first driven assembly is pivotally connected with the base and the bearing structure respectively, the second driven assembly is pivotally connected with the bearing structure or the base, and the first driven assembly and the second driven assembly are driven to move by pushing and pulling the driving member, to drive the bearing structure to lift and lower; and
a guide structure disposed on the base or the bearing structure and provided with a guide portion, wherein the guide portion cooperates with at least part of the second driven assembly, to guide the second driven assembly.

18. The AGV as claimed in claim 17, wherein one of the front frame and the rear frame is provided with a convex mounting portion, an other of the front frame and the rear frame is provided with a concave mounting portion, and the convex mounting portion extends into and is pivotally connected with the concave mounting portion, to connect the front frame and the rear frame.

19. The AGV as claimed in claim 17, wherein a stop structure is provided between the front frame and the rear frame, wherein
in an oscillating process of the front frame, the stop structure is used to limit and stop the front frame; or
in an oscillating process of the rear frame, the stop structure is used to limit and stop the rear frame; or
in an oscillating process of the front frame and the rear frame, the stop structure is used to limit and stop the front frame and the rear frame.

20. The AGV as claimed in claim 17, further comprising:
a driving wheel rotatably disposed on the oscillating axle;
a driven wheel rotatably disposed on the frame assembly, wherein the driving wheel is connected with the driven wheel, to drive the driven wheel to rotate; and
a driving wheel driving device , wherein the driving wheel driving device is drivingly connected with the driving wheel , to drive the driving wheel to rotate, and a part of the driving wheel driving device is embedded in the oscillating axle.
